(19) United States
(12) Patent Application Publication
(10) Pub. No.: US 2026/0084294 A1
(43) Pub. Date: Mar. 26, 2026

(54) ROBOT CONTACT FORCE MODEL

(71) Applicant: Intrinsic Innovation LLC, Mountain View, CA (US)

(72) Inventors: Kevin Sledge Tracy, Palo Alto, CA (US); Stefan Schaal, Mountain View, CA (US)

(21) Appl. No.: 19/336,296

(22) Filed: Sep. 22, 2025

Related U.S. Application Data
(60) Provisional application No. 63/697,378, filed on Sep. 20, 2024.

(51) Int. Cl. B25J 9/16; B25J 13/08

(52) U.S. Cl. CPC B25J 9/1605; B25J 9/163; B25J 9/1633; B25J 13/08

(57) ABSTRACT

Methods, systems, and apparatus, including computer programs encoded on computer storage media, for using a contact force model that predicts sensor values for robotic control. One of the methods includes continually providing, to a robot, control signals for performing a manipulation task of an object in the operating environment of the robot, including receiving data representing a current state of the robot, providing the current state of the robot to a contact force model configured to generate predicted sensor values based on the current state of the robot, receiving, as output of the contact force model, one or more predicted sensor values, and updating the control signals for the robot based on the one or more predicted sensor values

### CROSS-REFERENCE TO RELATED APPLICATIONS

This application claims the benefit under 35 U.S.C. § 119 (e) of the filing date of U.S. Provisional Patent Application No. 63/697,378, filed on Sep. 20, 2024, entitled “Robot Contact Force Model,” the entirety of which is herein incorporated by reference.

### BACKGROUND

This specification relates to robotics control.

Robotics control refers to controlling the physical movements of robots in order to perform tasks. For example, a robot can be programmed to pick up an object out of a bin and to place the object at a particular location in a workcell. Each of these actions can themselves include dozens or hundreds of individual movements by robot motors and actuators.

Some research has been conducted into using machine learning models for controlling robots. However, such models are very challenging to build for many robotics tasks, particularly for contact-rich manipulation tasks that require the robot or an object the robot is manipulating to make contact with objects in the operating environment. A common example is the task of connector insertion that can require a robot to insert a plug, such as an USB connector, into a receptacle.

### SUMMARY

This specification describes techniques for using a machine learning model to learn a relationship between a current state of a robot and predicted sensor data that will be experienced by the robot in that state. The current state of the robot can represent control commands and a pose of the robot or a component of the robot, e.g., the end effector. The predicted sensor data represents how contact of the robot, or an object manipulated by the robot, would generate sensor readings. For example, the predicted sensor data can predict values or vectors for force and torque experienced by an end effector of the robot. In this specification, such a model will be referred to as a contact force model.

The contact force model is advantageous because it greatly simplifies the processing required to react to forces in real-time. In particular, predictions made by the contact force model can be performed within a real-time control cycle of a physical robot. In some implementations, the contact force model is particularly fast because it learns a linear relationship between the current state of the robot and the predicted sensor data.

After being trained, the contact force model can be used to inform control policies on a physical robot or in simulation. This removes the need to perform a full and computationally expensive physics simulation when determining how contact forces will affect the robot.

Particular embodiments of the subject matter described in this specification can be implemented so as to realize one or more of the following advantages. The contact force model described in this specification improves the process of robotic control because actual forces experienced by a physical robot can be predicted within the tight timing window of a real-time control cycle, which is computationally impossible for a full physics simulation. The contact force model can also be used simulation in order to develop more sophisticated manipulation control policies. The more sophisticated control policies learned in simulation can then be executed in tandem with the contact force model on a physical robot. In other words, physical data can be used to learn a contact force model, which can be used in simulation to develop manipulation control policies, which can then be used on a physical robot. In a sense, the physical contact data is imported into the simulation by the contact force model, and the control policies developed in simulation are have high a likelihood of success on a physical robot because the same contact force model can be used in both domains.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of a system that uses a contact force model to predict sensor forces during a robotic manipulation task.

FIG. 2 is a flowchart of an example process for using a contact force model for robotics control.

FIG. 3 is a diagram illustrating how using a contact force model can reduce forces for a connector insertion task relative to a scripted routine.

Like reference numbers and designations in the various drawings indicate like elements.

### DETAILED DESCRIPTION

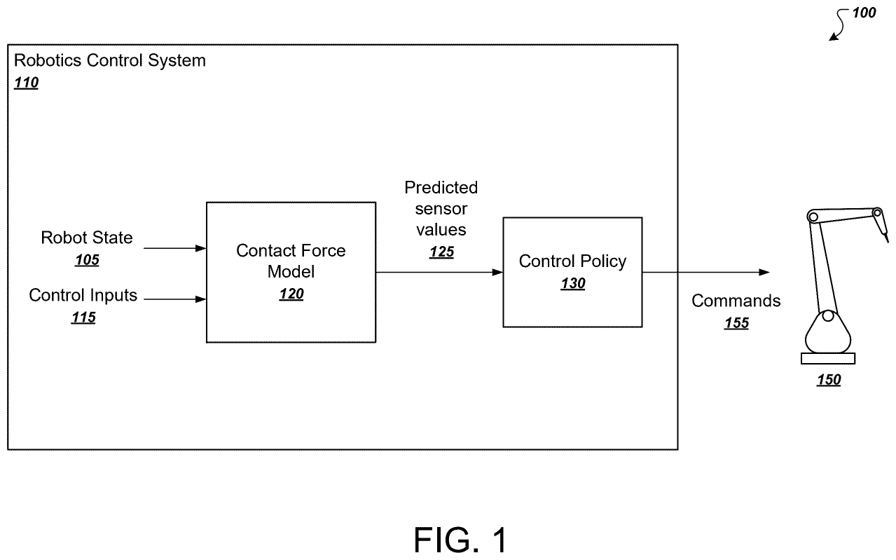

FIG. 1 is a diagram of a system 100 that uses a contact force model to predict sensor forces during a robotic manipulation task. The system includes a robotics control system 110, which implements a control policy 130 for performing a manipulation task using a physical robot 150.

The contact force model 120 receives as input a robot state 105 and control inputs 115 that are being used to drive the physical robot 150. The contact force model 120 can be implemented as a computing subsystem comprising one or more computers in one or more locations. However one of the main advantages of the techniques described in this specification is that the contact force model 120 is efficient enough to be executed during the tight timing windows of a real time robotics control cycle. Thus, in some implementations the contact force model 120 is executed by real-time control hardware.

The contact force model 120 generates predicted sensor values 125, which can include predicted torque and force that the robot is exerting on an object being manipulated. One of the areas in which the contact force model 120 is particularly useful is in the area of robotic connector insertion, where small deviations can result in unwanted large forces that can damage connectors. Using predicted sensor values 125 stabilizes the system and can reduce the forces on the model. The control policy 130 then uses the predicted sensor values 125 to generate commands 155 for driving the physical robot 150.

The robot state 105 can be generated based on sensors in the operating environment of the robot 150. The robot state 105 can also be based on a current joint configuration of the robot, or other state information of the robot.

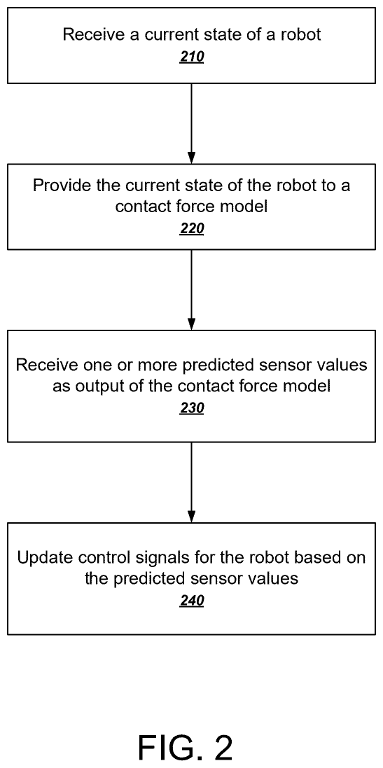

FIG. 2 is a flowchart of an example process for using a contact force model for robotics control. The example process can be performed by a system of one or more computers in one or more places that includes a robotics control system in communication with a robot. The process will be described as being performed by a system of one or more computers.

The system receives a current state of the robot (210). As described above, the state can be based on joint configurations as well as current control inputs of the robot. The system can generate a feature vector that represents these inputs.

The system provides the current state of the robot to a contact force model (220), and receives as output the predicted sensor values (230). In some implementations, the system computes the predicted sensor values using a learned linear relationship based on the input feature vector.

In other words, during training the system will can seek to learn a linear mapping G that transforms the feature vector w into the predicted sensor values y, e.g., predicted force, torque, or both. In other words, the goal is to learn G such that

$$y \approx Gw .$$

There are multiple benefits to representing the force model as a linear function of the feature vector, both in terms of system identification and control. For system identification, the resulting optimization problem is convex and can be solved to global optimality in real time with minimal computational cost. For control, as long as the feature vector is linear, the predicted force and torque can be minimized with convex optimization.

Instead of attempting to solve for G directly, the system can use decoupled model learning that solves each row of G independently. The resulting optimization problem over the jth row of G and y can be formulated as:

$${minimize}_{{g}^{( j )}} {\sum }_{k = 1}^{m} {‖ {( {g}^{( j )} )}^{T} {w}_{k} - {y}_{k}^{( j )} ‖}_{2}^{2} + {( {b}^{T} {g}^{( j )} )}^{2} ,$$

where g⁽ⁱ⁾ corresponds to the jth row of G. This allows the system to solve n_{y} parallel instances of this expression with n_{w} decision variables each instead of one large problem with n_{y}×n_{w} variables.

Optimizing this expression is an unconstrained convex optimization problem whose solution can be computed by solving a single linear system, with a solution complexity that is cubic in the length of the feature vector. In scenarios where online, real-time system identification is desired, a recursive method can be used that updates the solution for each new sensor measurement. One option for solving in a recursive fashion would be to use a standard Recursive Least Squares (RLS) algorithm.

Alternatively, the system can use a Kalman filter to estimate each row of G independently. A common structure amongst these n_{y} filters allows the system to handle the estimated G directly in a single, parallelizable fashion in which the most expensive operations are only matrix multiplications.

To start, the estimate of each row of G has its own Gaussian belief. Each of these ny beliefs are represented with a mean estimate and covariance. From here, the discrete-time dynamics for the filter are given by:

$$\begin{matrix}{g}_{k + 1}^{( j )} = {g}_{k}^{( j )} + {q}_{k}^{( j )} , & {q}^{( j )} \sim 𝒩 ( 0 , Q )\end{matrix} ,$$

where q represents additive Gaussian process noise with a covariance of Q.

This can also be interpreted as a more expressive version of a “forgetting factor”, where a nonzero process-noise covariance quantifies the expected change in parameters over the course of the computation, therefore putting more emphasis on newer measurements than old.

The measurement function in the filter for row j is where we use the row parameters g^{(j)} with our feature vector w to predict the jth measurement according to:

$${y}_{k}^{( j )} = {w}_{k}^{T} {g}_{k}^{( j )} + {v}_{k} , \qquad v \sim 𝒩 ( 0 , 1. ) ,$$

where v is the unknown sensor noise with a variance of 1.0. This measurement is a scalar, which means that the computation of the Kalman Gain only requires the inversion of a scalar instead of a matrix according to:

$$ℓ = ( \sum w ) {( {w}^{T} \sum w + 1 )}^{- 1} = \frac{\sum w}{{w}^{T} \sum w + 1} ,$$

which eliminates the only matrix inversion present in a Kalman filter.

Importantly, what's missing from these matrices is any reference to row j, meaning the filters for all n_{y} rows have the same process and measurement functions. This enables two important commonalities amongst the n_{y} filters: they all share the same covariance and Kalman Gain. Therefore, the system only needs to maintain a single “global” covariance that represents each of the n_{y} rows, and uses the shared Kalman Gain to update everything.

Using the Kalman Gain, the updates to the mean estimate of each row are given by:

$${\hat{g}}_{k + 1 \vert k + 1}^{( j )} = {\hat{g}}_{k + 1 \vert k}^{( j )} + ℓ ( {y}_{k + 1}^{( j )} - {\hat{g}}_{k + 1 \vert k}^{( j )} {w}_{k + 1} ) \qquad ∀ j ∈ [ 1 , {n}_{y} ] ,$$

and since the Kalman Gain is shared, these individual row updates can be broadcast to an estimate of the full matrix G according to:

$${\hat{G}}_{k + 1 \vert k + 1} = {\hat{G}}_{k + 1 \vert k} + ℓ ( {y}_{k + 1} - {\hat{G}}_{k + 1 \vert k} {w}_{k + 1} ) {ℓ}^{T} ,$$

where the parallelism is simply handled by a vector outer product and matrix addition. Using this technique on the parallel filters results in the algorithm detailed in TABLE 1:

TABLE 1
Linear Model Learning

Input: Ĝ_{k|k}, Σ_{k|k}, wₖ₊₁, [symbol] ₖ₊₁
/* predict belief updates */
Ĝ_{k+1|k} ← Ĝ_{k|k}
Σ_{k+1|k} ← Σ_{k|k} + Q
/* innovation and Kalman Gain */
z ← yₖ₊₁ − Ĝ_{k+1|k}wₖ₊₁
$s ← {w}_{t + 1}^{T} {\sum }_{k + 1 \vert k} {w}_{k + 1} + 1$ [symbol]
← Σ_{k +1|i}wₖ₊₁/s
/* update mean and covariance */
Ĝ_{k+1|k+1} ← Ĝ_{k+1|k} + z [symbol] ^{T}
${\sum }_{k + 1 \vert k + 1} ← ( I - ℓ {w}_{k + 1}^{T} ) {\sum }_{k + 1 \vert k} ( I - ℓ {w}_{k + 1}^{T} ) + {ℓℓ}^{T}$
Output: Ĝ_{k+1|k+1}, Σ_{k+1|k+1}

In addition, a regularization term can be included as an initialization. To do so, cost terms associated with the initial Gaussian belief are adapted to replicate the regularization in the form of an initial Gaussian belief over row j according to:

$${\hat{g}}_{0 \vert 0}^{( j )} = {0}_{{n}_{w}} , {Σ}_{0 \vert 0} = diag ( 1 / {b}^{2} ) .$$

With this initialization, the algorithm is called recursively every time a new measurement is available. The entire algorithm is matrix-inversion free, requiring only simple matrix products and additions that are trivial to parallelize on a GPU.

In order to compute values for G before attempting to perform a task using the predicted sensor measurements, the system can execute a calibration program that causes the robot to move in a way to generate training examples that represent a current state of the robot and sensor data representing contact of an object with the environment for the current state of the robot. The system can then continually update the contact force model using the training examples.

After computing the predicted sensor values using the trained contact force model, the system can update the control signals for the robot based on the predicted sensor values (240). For example, in some implementations, the system can use the predicted sensor values to solve for controls that minimize the resistance measured by a force-torque sensor.

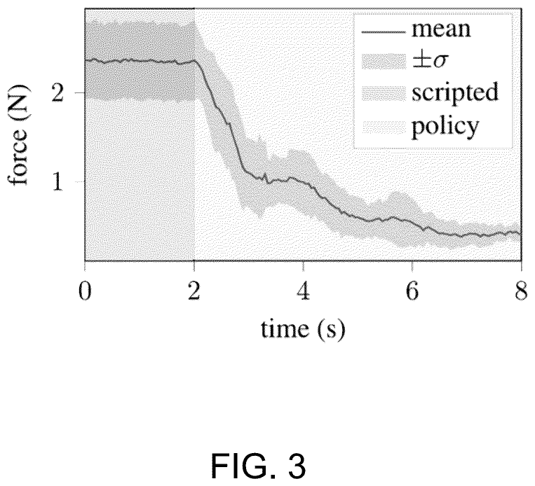

FIG. 3 is a diagram illustrating how using a contact force model can reduce forces for a connector insertion task relative to a scripted routine. This graph shows that the scripted insertion leaves a constant force on the plug, after which the policy based on predicted sensor values is used to reduce the actual force on the connector.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A computer-implement method comprising:
continually providing, to a robot, control signals for performing a manipulation task of an object in the operating environment of the robot, including:
receiving data representing a current state of the robot,
providing the current state of the robot to a contact force model configured to generate predicted sensor values based on the current state of the robot,
receiving, as output of the contact force model, one or more predicted sensor values, and
updating the control signals for the robot based on the one or more predicted sensor values.

2. The method of claim 1, wherein the predicted sensor values comprise predicted force, torque, or both, of contact of the object with another object in the operating environment.

3. The method of claim 1, wherein the manipulation task is a contact-rich manipulation task.

4. The method of claim 1, wherein the contact force model is a linear model.

5. The method of claim 1, wherein the contact force model can generate predicted sensor values within the real-time control cycle of the robot.

6. The method of claim 1, further comprising:
executing a calibration program for performing the manipulation task on a physical robot;
during execution of the calibration program, recording training examples that represent a current state of the robot and sensor data representing contact of an object with the environment for the current state of the robot; and
training the contact force model using the training examples.

7. The method of claim 6, further comprising using the trained contact force model to control a physical robot.

8. The method of claim 6, further comprising using the trained contact force model to control a robot in simulation.

9. A system comprising:
one or more computers and one or more storage devices storing instructions that are operable, when executed by the one or more computers, to cause the one or more computers to perform operations comprising:
continually providing, to a robot, control signals for performing a manipulation task of an object in the operating environment of the robot, including:
receiving data representing a current state of the robot,
providing the current state of the robot to a contact force model configured to generate predicted sensor values based on the current state of the robot,
receiving, as output of the contact force model, one or more predicted sensor values, and
updating the control signals for the robot based on the one or more predicted sensor values.

10. The system of claim 9, wherein the predicted sensor values comprise predicted force, torque, or both, of contact of the object with another object in the operating environment.

11. The system of claim 9, wherein the manipulation task is a contact-rich manipulation task.

12. The system of claim 9, wherein the contact force model is a linear model.

13. The system of claim 9, wherein the contact force model can generate predicted sensor values within the real-time control cycle of the robot.

14. The system of claim 9, wherein the operations further comprise:
executing a calibration program for performing the manipulation task on a physical robot;
during execution of the calibration program, recording training examples that represent a current state of the robot and sensor data representing contact of an object with the environment for the current state of the robot; and
training the contact force model using the training examples.

15. The system of claim 14, wherein the operations further comprise using the trained contact force model to control a physical robot.

16. The system of claim 14, wherein the operations further comprise using the trained contact force model to control a robot in simulation.

17. One or more non-transitory computer storage media encoded with computer program instructions that when executed by one or more computers cause the one or more computers to perform operations comprising:
continually providing, to a robot, control signals for performing a manipulation task of an object in the operating environment of the robot, including:
receiving data representing a current state of the robot,
providing the current state of the robot to a contact force model configured to generate predicted sensor values based on the current state of the robot,
receiving, as output of the contact force model, one or more predicted sensor values, and
updating the control signals for the robot based on the one or more predicted sensor values.

18. The one or more computer storage media of claim 17, wherein the predicted sensor values comprise predicted force, torque, or both, of contact of the object with another object in the operating environment.

19. The one or more computer storage media of claim 17, wherein the manipulation task is a contact-rich manipulation task.

20. The system of claim 17, wherein the contact force model is a linear model.
